(19) United States
(12) Patent Application Publication
(10) Pub. No.: US 2007/0246996 A1
(43) Pub. Date: Oct. 25, 2007

(54) Ornamental wheel

(76) Inventor: Paul F. Footit, Springfield, MA (US)

Correspondence Address: Paul F. Footit, 26 Kipling Street, Springfield, MA, 01118, US

(21) Appl. No.: 11/484,965

(22) Filed: Jul. 12, 2006

Related U.S. Application Data
(60) Provisional application No. 60/745,528, filed on Apr. 25, 2006.

(51) Int. Cl. B60B 7/00

(52) U.S. Cl. 301/37.108

(57) ABSTRACT

The wheel of the present invention features a central hub enclosing recessed appendages. The appendages are preferable fin shaped or blade shaped. As the rotation of the wheel increases in speed, the appendages will extend out of the central hub due to centrifugal force. When fully extended, the appendages will extend to the outer-diameter of the tire. As the rotation of the wheel decreases in speed, the appendages will retract back into the hub. Tension from a spring or similar mechanism may be used to maintain the appendages in the recessed position when the wheel in not in motion. The present invention may also be in the form of wheel cover, such as a hubcap, wherein the recessed appendages are enclosed within the central portion of the wheel cover. The wheel cover is intended to be fastened to the wheel of an automobile in the same manner as hubcaps of the prior art. As the rotation of the wheel increases in speed, the appendages will extend out of the wheel cover due to centrifugal force. When fully extended, the appendages will extend to the outer-diameter of the tire. As the rotation of the wheel decreases in speed, the appendages will retract back into the wheel cover. Tension from a spring or similar mechanism may be used to maintain the appendages in the recessed position when the wheel in not in motion.

### CROSS-REFERENCE TO RELATED APPLICATIONS

This application claims priority from provisional application, Ser. No. 60/745,528, filed Apr. 25, 2006, which is fully incorporated herein by reference.

### BACKGROUND OF THE INVENTION

1. Field of the Invention

The present invention relates to automobile wheel and tire ornamentation. More particularly, the present invention relates to an automobile wheel having fin shaped or blade shaped appendages enclosed in a central hub. As the wheel rotates, the appendages extend out of the central hub and extend to the outer diameter of the tire.

2. Description of Related Art

Wheel ornamentation is popular among many automobile owners, as evidenced by chrome wheel covers and rims, rotating hubcaps or spinning ornaments that have been developed for the automobile wheel. A number of spinning wheel covers or hubcaps have been developed for automobiles, as discussed below. However, a decorative effect other than a spinning wheel or hubcap is desired.

U.S. Patent Publication Number 2003/0102712, published on Jun. 5, 2003, describes an automobile wheel ornament in the form of a spinner and an adapter. The adapter is attached to the wheel by lug nuts and provides a mounting surface for the spinner. The adapter has a variety of bolt-hole openings to accommodate for the different types of lug nut patterns on a car wheel. The spinner rotates, whether or not the wheel is in motion, because of a ball bearing system positioned between the spinner and the adapter.

U.S. Pat. No. 3,158,946, issued to Upchurch on Dec. 1, 1964, describes a spinning hubcap for the exterior face of a vehicle's wheels. The hubcap has two parts, including a rotating outer spoke portion and a stationary inner metal disc. The wheel has an annular rim that holds the disc in place and an axial tube extending from the center of the wheel to which the hubcap mounts. The spoke portion of the hubcap is mounted on the axial tube by a ball bearing system. As the wheel rotates forward, the spoke portion of the hubcap also rotates forward. The spokes continue to rotate forward, even after the wheel stops because of inertia and the bearing system. The bearing system works in conjunction with a ratchet and cam system.

U.S. Pat. No. 5,290,094, issued to Gragg on Mar. 1, 1994, describes an automotive wheel enhancer mounted to the center cap of a wheel. A mounting piece holds the wheel enhancer to the wheel. The mounting piece comprises a first mounting member that houses a second mounting member. Each mounting member has a threaded stud facing opposite directions from one another. One stud is inserted into the wheel enhancer and the other stud is inserted into the wheel. A bearing system located between the mounting members permit the members to rotate independently of one another, and consequently the wheel enhancer to rotate independently of the wheel.

U.S. Pat. No. 2,997,344, issued to Whiteman on Aug. 22, 1961, describes a wheel cover for motor vehicles. The wheel cover is a two-part hubcap having a rotating colored inner hub and a stationary outer hub. The outer hub is fixedly attached to the wheel. The inner hub is mounted on a bolt by a bearing assembly and rotates independently of the outer hub, therefore when the wheel and the outer hub stops rotating the inner hub continues to spin due to inertia. German Patent Number 3,919,268, published on Jan. 3, 1991, shows a hubcap having an inner hub and an outer hub. The inner hub is attached to the wheel and supports the outer hub. When the wheel is in motion, the inner hub rotates with the wheel, but the outer hub is relatively stationary because of a weight placed on the edge of the outer hub.

Other spinning wheel ornaments have been developed that uses weights to modify rotation speed or air to move the wheel's ornament. U.S. Pat. No. 6,554,370, issued to Fowlkes on Apr. 29, 2003, describes a wheel spinner assembly that rotates independently of the wheel due to a bearing system. The bearing assembly attaches the spinner to the wheel in one of three places: at the center of the spinner, at the distal ends of the spinner's spoke, or around the wheel mount. Screws inserted into the distal ends of the spinner spoke weigh the spinner down and allow the spinner to rotate at a different speed from the wheel's cover.

U.S. Pat. No. 3,005,906, issued to Butler Jr. on Oct. 24, 1961, describes a hubcap ornament for a vehicle in the form of a rocket. The rocket is mounted on a screw that is inserted through the center of the hubcap. The rocket moves only 90.degree. The rocket is horizontal when air pressure pushes a fin/vane disposed at the rocket's bottom up; otherwise the rocket remains vertical because of gravity pulling down on a weight located at the bottom of the rocket.

U.S. Pat. No. 3,722,958, issued to Marshall on Mar. 27, 1973, describes a wheel cover for automotive vehicles that rotates independently of the wheel's rotation, producing a decorative effect. The wheel cover rotates around a shaft by a bearing system due to the wheel's motion as well as air force drawn past louvers disposed on the cover. The cover rotates independently of the wheel. The shaft can be attached to the wheel by lugs.

U.S. Pat. No. 3,219,391, issued to Hettinger on Nov. 23, 1965, describes a wheel disc cover for automobiles, motorcycles, bicycles, etc. that rotate independently of the wheel's motion. The cover is mounted on a shaft over a ball bearing system. The cover rotates because of air flowing past a number of raised air scoops disposed on the cover's surface. The cover rotates in either a forward direction or a rearward direction, depending on which direction the open side of the air scoops face.

U.S. Pat. No. 2,762,469, issued to Lyon on Sep. 11, 1956, describes a wheel cover having a number of openings and vanes adjacent to each opening disposed on the surface of the cover. The wheel cover is mounted by a bearing assembly on a spindle to a hub of the wheel. The vanes at the openings on the wheel cover are set at fixed intervals and are moved by slipstream air. The air entering the vanes is used- to cool the brake drum.

None of the above inventions and patents, taken either singly or in combination, is seen to describe the instant invention as described herein.

### SUMMARY OF THE INVENTION

The wheel of the present invention features a central hub enclosing recessed appendages. The appendages are preferable fin shaped or blade shaped. As the rotation of the wheel increases in speed, the appendages will extend out of the central hub due to centrifugal force. When fully extended, the appendages will extend to the outer-diameter of the tire. As the rotation of the wheel decreases in speed, the appendages will retract back into the hub. Tension from a spring or similar mechanism may be used to maintain the appendages in the recessed position when the wheel in not in motion.

The present invention may also be in the form of wheel cover, such as a hubcap, wherein the recessed appendages are enclosed within the central portion of the wheel cover. The wheel cover is intended to be fastened to the wheel of an automobile in the same manner as hubcaps of the prior art. As the rotation of the wheel increases in speed, the appendages will extend out of the wheel cover due to centrifugal force. When fully extended, the appendages will extend to the outer-diameter of the tire. As the rotation of the wheel decreases in speed, the appendages will retract back into the wheel cover. Tension from a spring or similar mechanism may be used to maintain the appendages in the recessed position when the wheel in not in motion.

### BRIEF DESCRIPTION OF THE DRAWINGS

The ornamental wheel cover will now be described, by way of example only, with reference to the accompanying drawings, which are meant to be exemplary, not limiting, and wherein like elements are numbered alike in several FIGURES, in which:

FIG. 1, is a frontal view of the assembly arrangement of the present invention.

FIG. 2, is a frontal view of the assembly arrangement of the present invention with the appendages in an extended position.

FIG. 3, is a frontal view of a preferred embodiment of a single appendages in accordance with the present invention.

FIG. 4, is a side view of FIG. 3.

FIG. 5, is a side view of FIG. 3.

FIG. 6, is a side view of FIG. 3.

### DETAILED DESCRIPTION OF THE PREFERRED EMBODIMENTS

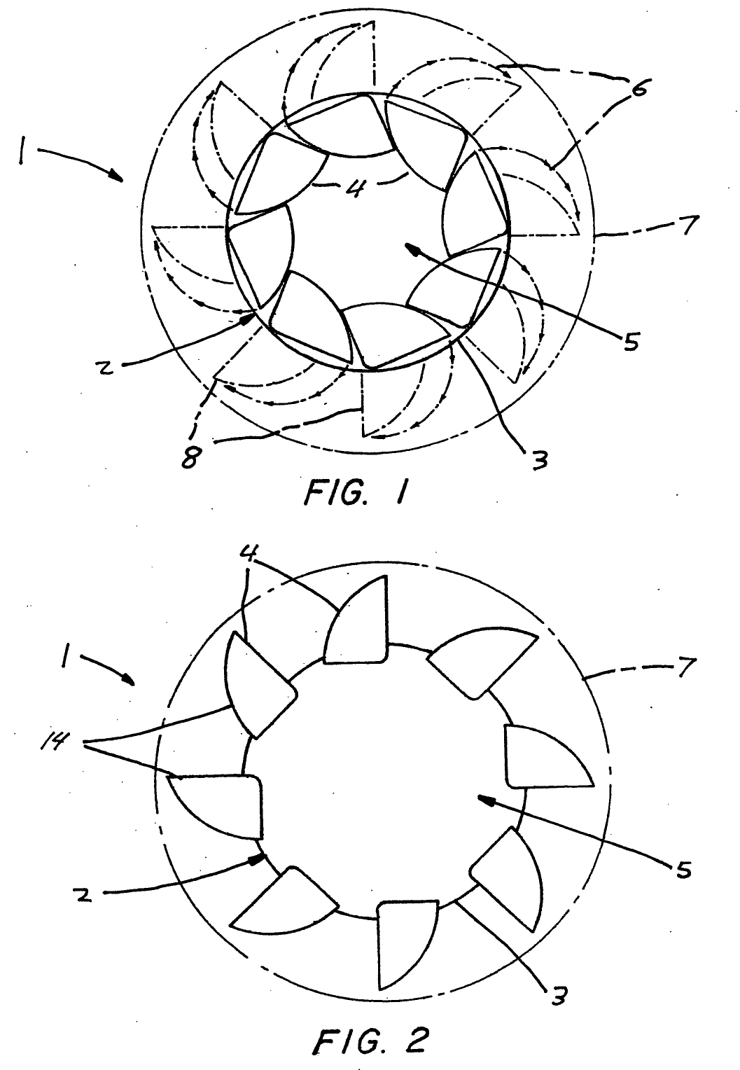

A preferred embodiment of the assembly arrangement of the present invention is shown in FIGS. 1 and 2. Referring initially to FIG. 1, an assembly arrangement 1 comprises a wheel cover that may be mounted or otherwise attached to a vehicle wheel via mounting disc 3. The wheel cover 2 includes a number of appendages 4, preferably having a shape similar to a fin or blade. The appendages 4 are attached to the assembly at the central hub area 5 of the wheel cover 2 by a spring or hinge or other well-known fastening mechanism to allow for rotation of each appendage 4 at the point of attachment to the mounting disc 3. The appendages are held in a recessed or retracted position by an extendable or elastic fastening mechanism such as a spring or hinge in the central hub area 5 of the wheel cover 2 when the wheel is not in motion as shown in FIG. 1. As further shown in FIG. 1, the appendages 4 will move out of the recessed position, preferably rotating in direction 6, as the wheel rotates due to centrifugal force generated by the rotation of the wheel. The appendages 4 will extend further out from the central hub area 5 of the wheel cover 2 as the rate of rotation of the wheel increases. When in their fully extended position 8, the appendages 4 will extend towards the outer diameter 7 of the wheel as shown in FIG. 2. As the rotation of the wheel slows, causing a corresponding decrease in centrifugal force, the appendages 4 recede back towards the central hub area of the wheel, eventually returning to their fully recessed position when the wheel comes to a complete stop.

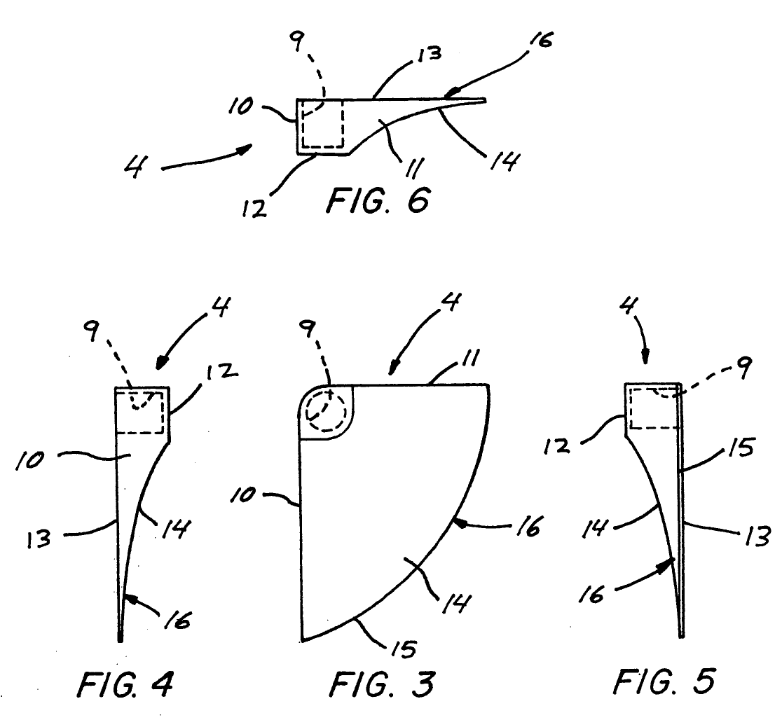

Referring now to FIGS. 3-6, a preferred embodiment of a single appendage 4 is shown. In a preferred embodiment, appendage 4 is attached to mounting disc 3 at internal bore 9. While it should be appreciated that the appendage 4 is not limited to any particular size or shape, a preferred embodiment of the appendage 4 is in the shape of a curved blade or fin 16 having a first flat side edge 10, a second flat side edge 11, a flat face 12, a flat inner surface 13, and a curved concave outer surface 14, and a curved outer edge.

A person of skill in the art will recognize that the assembly of the present invention can be manufactured in accordance with methods and materials well-known in the art for making wheels and wheel covers for automobiles. Further, the it will be understood by a person of skill in the art that the invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A wheel cover assembly connectable to a wheel of a vehicle comprising:
a wheel mount;
a plurality of fin shaped appendages wherein each appendage is fastened to the wheel assembly at a single point of attachment in a central hub area of the wheel assembly; and
wherein each appendage is held in a retracted position by an elastic fastener in the central hub area of the wheel when the wheel is not in motion; and
wherein each appendage rotates at its point of attachment as the wheel rotates so as to move out of the retracted position into an extended position.

2. The wheel cover assembly of claim 1 wherein said elastic fastener comprises a spring.

3. A wheel cover assembly connectable to a wheel of a vehicle comprising:
a wheel mount;
a plurality of blade shaped appendages wherein each appendage is fastened to the wheel assembly at a single point of attachment in a central hub area of the wheel assembly; and
wherein each appendage is held in a retracted position by an elastic fastener in the central hub area of the wheel when the wheel is not in motion; and
wherein each appendage rotates at its point of attachment as the wheel rotates so as to move out of the retracted position into an extended position.

4. The wheel cover assembly of claim 3 wherein said elastic fastener comprises a spring.

5. A wheel assembly comprising:
a plurality of fin shaped appendages wherein each appendage is fastened to the wheel assembly at a single point of attachment in a central hub area of the wheel assembly; and
wherein each appendage is held in a retracted position by an elastic fastener in the central hub area of the wheel when the wheel is not in motion; and
wherein each appendage rotates at its point of attachment as the wheel rotates so as to move out of the retracted position into an extended position.

6. The wheel assembly of claim 5 wherein said elastic fastener comprises a spring.

7. A wheel assembly comprising:
a plurality of blade shaped appendages wherein each appendage is fastened to the wheel assembly at a single point of attachment in a central hub area of the wheel assembly; and
wherein each appendage is held in a retracted position by an elastic fastener in the central hub area of the wheel when the wheel is not in motion; and
wherein each appendage rotates at its point of attachment as the wheel rotates so as to move out of the retracted position into an extended position.

8. The wheel assembly of claim 7 wherein said elastic fastener comprises a spring.
